(19) United States
(12) Patent Application Publication
(10) Pub. No.: US 2022/0138080 A1
(43) Pub. Date: May 5, 2022

(54) COMPUTER-IMPLEMENTED METHOD AND DEVICE FOR SELECTING A FUZZING METHOD FOR TESTING A PROGRAM CODE

(71) Applicant: Robert Bosch GmbH, Stuttgart (DE)

(72) Inventors: Anupam SARKAR, Kolkata (IN); Christopher Huth, Weil Der Stadt (DE); Hans Loehr, Nürnberg (DE); Simon Greiner, Leonberg (DE)

(21) Appl. No.: 17/453,077

(22) Filed: Nov. 1, 2021

(30) Foreign Application Priority Data
Nov. 4, 2020 (DE) 10 2020 213 890.7

(51) Int. Cl. G06F 11/36

(52) U.S. Cl. CPC G06F 11/362

(57) ABSTRACT

A computer-implemented method for selecting a fuzzing method for carrying out fuzzing testing of a predefined program code. The method includes: providing program code metrics that characterize the program code to be tested; applying the program code metrics to a data-based fuzzing selection model for ascertaining performance metrics, associated with the fuzzing methods, for a number of fuzzing methods, the data-based fuzzing selection model being trained to output a performance metric for each of the fuzzing methods; selecting one or multiple fuzzing methods corresponding to the associated performance metrics; carrying out fuzzing testing corresponding to the one or multiple selected fuzzing methods.

### FIELD

The present invention relates to methods for testing a program code via so-called fuzzing testing. The present invention relates in particular to measures for selecting a fuzzing method for fuzzing testing of a certain program code.

### BACKGROUND INFORMATION

A conventional method for detecting errors in a program code which is executed on a computer system and which may be implemented in software or hardware is to examine the program code for program execution errors or system crashes with the aid of a fuzzing test method. In the process, the so-called fuzzing inputs are generated for the computer system, a program code to be tested is executed using the inputs, and the functioning of the algorithm of the program code is supervised. The supervision of the execution of the program code includes establishing whether the running of the algorithm results in a program execution error such as a system crash or unexpected execution stop.

During the execution of the program, the internal behavior of the program sequence is supervised, in particular with regard to the sequence paths carried out by the program code. This procedure is repeated using different inputs in order to obtain a piece of information concerning the behavior of the program code for a wide range of inputs. The objective of the program code supervision is to generate the inputs in such a way that the greatest possible coverage of the program sequence paths is achieved, i.e., the greatest possible number of program sequence paths is run through during the repeated variation of the inputs.

If an error or an unexpected behavior occurs during an execution of a program code, this is recognized by the fuzzing tool and signaled via appropriate information that indicates which fuzzing input has resulted in the error.

### SUMMARY

According to the present invention, a computer-implemented method for selecting a fuzzing method for carrying out a fuzzing test is provided, and a method for training a data-based fuzzing selection model for selecting a fuzzing method as well as a corresponding device are provided.

Further embodiments of the present invention are disclosed herein.

According to a first aspect of the present invention, a computer-implemented method for selecting a fuzzing method for carrying out fuzzing testing of a predefined program code is provided. In accordance with an example embodiment of the present invention, the method includes the following steps:
providing program code metrics that characterize the program code to be tested;
applying the program code metrics to a data-based fuzzing selection model for ascertaining performance metrics, associated with the fuzzing methods, for a number of fuzzing methods, the data-based fuzzing selection model being trained to output a performance metric for each of the fuzzing methods;
selecting one or multiple fuzzing methods corresponding to the associated performance metrics;
carrying out fuzzing testing corresponding to the one or multiple selected fuzzing methods.

According to a further aspect of the present invention, a method for training a data-based fuzzing selection model is provided. In accordance with an example embodiment of the present invention, the method includes the following steps:
providing program codes from a predefined program code collection;
carrying out fuzzing test methods of the program codes corresponding to the predefined fuzzing methods;
ascertaining a performance metric for each fuzzing test method carried out for each program code;
ascertaining a set of one or multiple program code metrics for each of the program codes, so that training data sets are formed, which for a fuzzing method and a program code tested therewith, associate a set of the one or multiple program code metrics with the corresponding performance metric;
creating the data-based fuzzing selection model based on the training data sets, so that a performance metric is associated with a set of one or multiple program code metrics.

Numerous fuzzing methods are available, which may be subdivided essentially into the classes of source code fuzzing and protocol fuzzing. The source code fuzzing is used to find errors in a program code, an attempt being made to test the greatest possible number of program sequence paths in the program code with regard to an undesirable program sequence. For protocol fuzzing, the communication of a program code is supervised in that communication messages are delayed, intercepted, manipulated, and the like in order to trigger an undesirable system behavior. The fuzzing software is used as a “man-in-the-middle” unit between two subunits of the system to be tested.

For the source code fuzzing, several fuzzing methods are presently available that are implemented in various fuzzing software tools. Examples of such fuzzing software tools are American Fuzzy Lop, libFuzzer, or honggfuzz.

In addition, the fuzzing methods may start with various seed data as inputs, which significantly influence the course of the fuzzing test. The fuzzing testing is based to a large extent on randomness, so that the selected seed file as well as the random selections make it difficult to compare fuzzing methods during the testing.

Therefore, the same seed data are to be used for comparing the fuzzing software tools.

A seed file represents a minimum set of valid inputs. Programs that are based on the same inputs should have the same seed data. This applies in particular for media formats such as PNG, JPG, PDAF, AVI, MP3, GIF, but also for other data structures such as PDF, ELF, XML, SQL, and the like.

In addition, the fuzzing software tools are intended to use the same dictionaries for the same input type of the seed data used. A dictionary includes a default set for certain inputs such as fault injection patterns and the like, and in particular contains entries in the form of characters, symbols, words, binary character strings, or the like, which typically are an integral part of the input value for the software to be tested. There are also general dictionaries, for example for PDF, ELF, XML, or SQL parsers, as well as individual dictionaries for only one type of software. Dictionaries are used to aid the fuzzer in generating inputs, which result in a longer execution path in the software to be tested.

A fuzzing method is accordingly characterized by the fuzzing software tool, the seed data, and the dictionary used. Further aspects according to which the fuzzing methods may be differentiated include fuzzing test parameters such as a limitation of the available memory, a setting of a time-out for each test case, a mode or a selection of heuristics of the fuzzing tool, a use of a grammar, and the like. Additional criteria may relate to the testing period of the fuzzing test, the data processing platform on which the fuzzing software tool is operated, as well as the configuration thereof.

One feature of the method in accordance with the present invention is to provide a fuzzing selection model which allows selection and configuration of a suitable fuzzing method for the fuzzing testing, based on program code metrics that characterize the program code based on statistical features.

In accordance with an example embodiment of the present invention, for this purpose, the program code metrics may include one or multiple of the following metrics, for example: number of code lines, cyclomatic complexity, average quantity of the program sequence paths, simple execution time, load time, program code size, number of potentially dangerous function calls (memcpy, for example), number of memory accesses, and the like.

With the aid of the data-based fuzzing selection model, a performance metric results for various fuzzing methods, which are classified by the fuzzing selection model. One or multiple of the fuzzing methods for the fuzzing testing of the provided program code may be ascertained, corresponding to the performance metric. Such a performance metric may include or be a function of the coverage of the program sequence paths, in particular a functional coverage, program line coverage, or path coverage, the number of executed program sequence paths, the number of different errors that are found, and the average fuzzing execution time.

In particular, the fuzzing method having the highest value of the performance metric may thus be selected for the fuzzing testing.

The data-based fuzzing selection model may be a classification model, and may be formed with the aid of a neural network, for example. Alternatively, the fuzzing selection model may also be provided as a linear regression or a lookup table (assignment function) that indicates which fuzzing method was the best in the past.

The fuzzing selection model may be trained based on data. For this purpose, for example program codes, which may include code snippets, code examples, or actual software, may be provided in a program code collection. These are to be provided in each case with at least one artificial or known real error (Common Vulnerabilities and Exposures (CVE)) that results in a program abortion when the program sequence path in question is executed.

The selection of the program code collection for training the fuzzing selection model may be established, or this may be selected corresponding to the performance metric to be assessed, based on reinforcement learning methods. Training data sets are created for the training, initially the program code metrics for the program codes of the program code collection being ascertained.

Reinforcement learning may be used when, during a training of the fuzzing selection model, an observed performance metric (coverage, for example) no longer changes or changes too little, and the program (timeout, for example) is then slightly adapted for the next fuzzing run in order to (hopefully) maximize the performance metrics.

In addition, each of the program codes of the provided program code collection is tested with the aid of each of the provided fuzzing methods. The testing takes place under the same conditions; i.e., data processing devices of the same level of performance and the same test duration are assumed. The test result is subsequently assessed with regard to one or multiple of the performance metrics.

The data-based fuzzing selection model may now be trained, in particular as a classification model, the program code metrics being mapped onto an output vector which predefines the corresponding performance metric for each of the fuzzing methods.

### BRIEF DESCRIPTION OF THE DRAWINGS

Specific embodiments are explained in greater detail below with reference to the figures.

FIG. 1 shows a block diagram for illustrating a system for selecting a fuzzing method for testing a program code, in accordance with an example embodiment of the present invention.

FIG. 2 shows a flowchart for illustrating the method for selecting a fuzzing method for a fuzzing test of a predefined program code, in accordance with an example embodiment of the present invention.

FIG. 3 shows a block diagram for illustrating the function of a system for training a fuzzing selection model, in accordance with an example embodiment of the present invention.

FIG. 4 shows a flowchart for illustrating a method for training a fuzzing selection model for use in a system from FIG. 3, in accordance with an example embodiment of the present invention.

### DETAILED DESCRIPTION OF EXAMPLE EMBODIMENTS

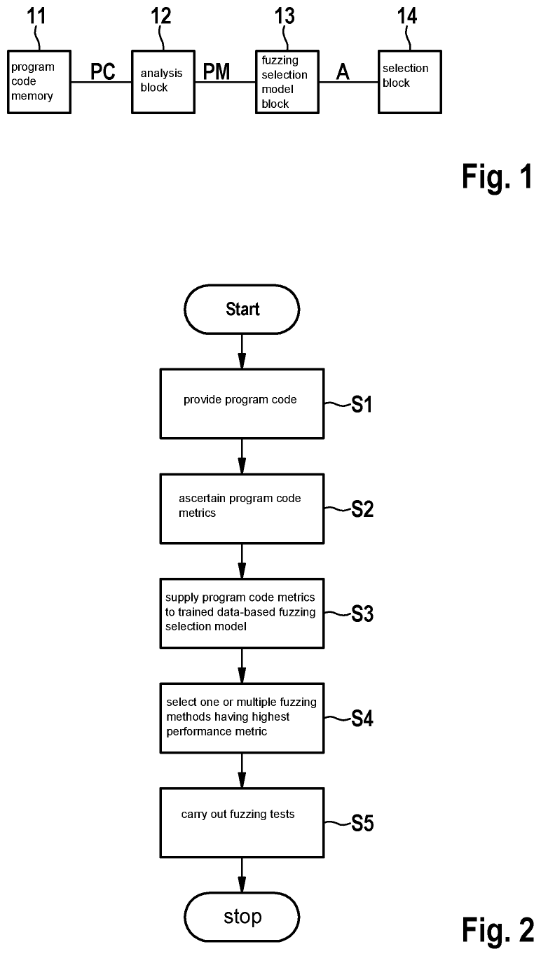

FIG. 1 shows a block diagram for illustrating the function for selecting one or multiple fuzzing methods for a fuzzing test of a predefined program code. The function is described in greater detail below with reference to the flowchart of FIG. 2. The method and functionality of the system are provided in a data processing device.

A program code PC is provided in step S1. Program code PC may correspond to a code snippet, a code example, or actual software that is to be tested with the aid of a fuzzing test. Program code PC may be provided so as to be retrievable from a program code memory 11. The program code must be compilable, interpretable, and executable in order to carry out the fuzzing test.

Program code metrics PM are ascertained from the predefined program code in an analysis block 12 in step S2. Program code metrics PM may include one or multiple of the following metrics: cyclomatic complexity, command path length (number of machine code commands of the overall program path length), number of code lines, the program execution time, the program load time, and the program size (in bytes). Program code metrics PM are selected in such a way that they characterize the predefined program code, and are intended to be ascertainable in particular via a few program executions, in particular one program execution, of the provided program code.

The cyclomatic complexity, also referred to as the McCabe metric, is used to determine the complexity of a software module (function, procedure, or in general a segment of source code). It is defined as the number of linearly independent paths on the control flow graph of a program code, and thus as an upper limit for the minimum number of test cases that are necessary to achieve complete branch coverage of the control flow graph.

Program code metrics PM are supplied to a trained data-based fuzzing selection model in a fuzzing selection model block 13 in step S3 in order to obtain a classification result for the fuzzing methods that are taken into account in the fuzzing selection model.

The fuzzing selection model corresponds to a data-based classification model that is trained to output in each case a performance metric for a number of considered fuzzing methods as a function of the program code metrics, for example in the form of an output vector A. The performance metric in each case indicates how well the fuzzing method in question is suited for testing the predefined program code. This performance metric may have a value range between 0 and 1, for example.

The one or multiple fuzzing methods having the highest performance metric may be selected in a selection block 14 in step S4, as a function of the output vector, in order to appropriately test the predefined program code using fuzzing test methods corresponding to the fuzzing method.

The selected fuzzing methods are used to carry out fuzzing tests in step S5. The one or multiple selected fuzzing methods are thus applied to the program code in an execution block, corresponding to the result of the fuzzing selection model.

Fuzzing methods differ primarily by the fuzzing software tool used and by the initially provided seed data, which provide initial inputs for the fuzzing testing. The dictionary used, the processing capacity, the testing period, the minimum number of program executions, and possible configurations of the fuzzing software tool represent further parameters for the selected fuzzing methods.

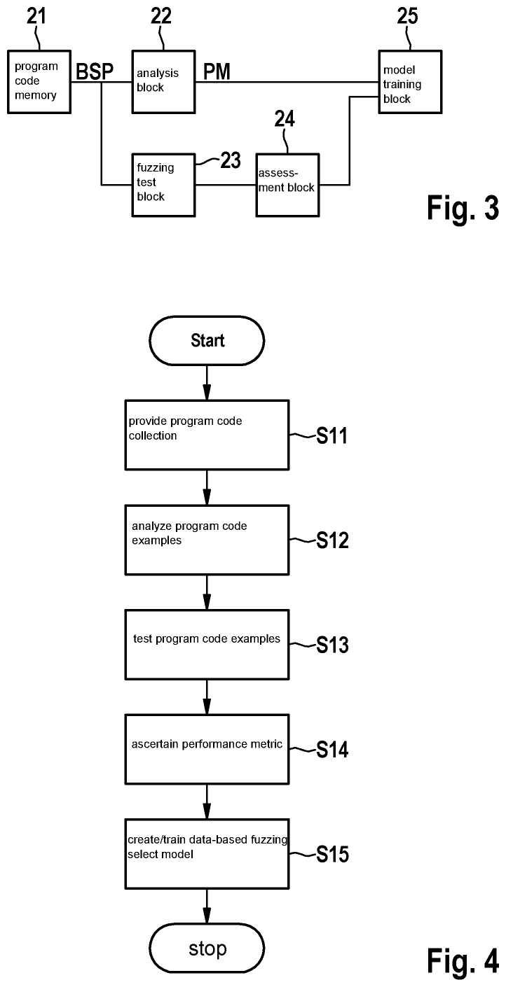

FIG. 3 illustrates a block diagram for illustrating a function for training a data-based fuzzing selection model. The function is explained in greater detail with reference to the flowchart of FIG. 4. The method described therein may be carried out on a conventional data processing device.

For training the fuzzing selection model, training data sets are used, each of which maps one or multiple program code metrics onto an output vector. The output vector classifies the program code metric corresponding to a fuzzing method. For this purpose, each element of the output vector may be associated with a different fuzzing method, and may have a value that corresponds to a performance metric. The value denotes the suitability of the fuzzing method in question for the type of program code that is characterized by the program code metrics.

At the start of the method, a program code collection (benchmark suite) is provided with a number of various program code examples BSP in a program code memory 21 in step S11. The program code collection may be provided as a fixed suite, for example the DARPA CGC binaries, LAVA test suite, Google Fuzzer Suite, NIST Software Assurance Metrics And Tool Evaluation (SAMATE), FEData, as an evolvable suite, for example as provided in Klees G. et al., “Evaluating fuzz testing,” in Proceedings of the 2018 ACM SIGSAC Conference on Computer and Communications Security, CCS 2018, pages 2123-2138, New York, N.Y., US, 2018, and/or as a labeled suite, which provides a program code collection for differentiating the error types and which is provided, for example, with the Google Fuzzer Suite and the NIST SAMATE project.

Program code examples BSP are appropriately analyzed in an analysis block 22 in step S12 in order to ascertain program code metrics PM in each case.

In addition, program code examples BSP are tested in step S13 with the aid of fuzzing test methods corresponding to the provided fuzzing methods, using a series of selected fuzzing methods which are carried out in a fuzzing test block 23.

A performance metric is ascertained in an assessment block 24 in step S14 as the result of the testing. The performance metric may include or be a function of one or multiple of the following metrics: the test coverage, the number of executed program sequence paths, an error recognition rate (for example, the number of recognized errors), and an average fuzzing execution time. The performance metric may take one or multiple of these metrics into account and associate it/them with a corresponding measure. A vector whose elements indicate the associated performance metric for each of the fuzzing methods in question is subsequently created from the performance metrics.

With the aid of suitable machine learning methods, a data-based fuzzing selection model may now be created/trained in a model training block 25 in step S15, using training data sets which associate the program code metrics, associated with a program code example of the program code collection, with the corresponding vector. For example, the machine learning methods may include Gaussian process models or neural networks as a fuzzing selection model.

Statistical learning methods and reinforcement learning represent further options for designing the fuzzing selection model.

1-9. (canceled)

10. A computer-implemented method for selecting a fuzzing method for carrying out fuzzing testing of a predefined program code, comprising the following steps:
providing program code metrics that characterize the program code to be tested;
applying the program code metrics to a data-based fuzzing selection model for ascertaining performance metrics, associated with each fuzzing method of a number of fuzzing methods, the data-based fuzzing selection model being trained to output an associated performance metric for each of the fuzzing methods;
selecting one or multiple of the fuzzing methods corresponding to the associated performance metrics; and
carrying out fuzzing testing corresponding to the selected one or multiple fuzzing methods.

11. The method as recited in claim 10, wherein each of the fuzzing methods is characterized by a fuzzing software tool used, and by: (i) seed data used and/or (ii) a dictionary used, and/or (iii) one or multiple of the following fuzzing test parameters or fuzzing tool configurations: a limitation of an available memory, a setting of a time-out for each test case, a mode or a selection of heuristics of the fuzzing software tool, a use of a grammar, a testing period of a fuzzing test, at least one property of a data processing platform on which the fuzzing software tool is operated, an a configuration of the fuzzing software tool.

12. The method as recited in claim 10, wherein the associated performance metric characterizes the fuzzing method based on statistical features, and includes or is a function of one or multiple of the following variables: coverage of program sequence paths, a functional coverage, program line coverage, or path coverage, a number of executed program sequence paths, a number of different errors that are found, average fuzzing execution time.

13. The method as recited in claim 10, wherein the program code metrics include one or multiple of the following metrics: number of code lines, cyclomatic complexity, average quantity of program sequence paths, simple execution time, load time, number of function calls, number of memory accesses, program code size.

14. The method as recited in claim 10, wherein the data-based fuzzing selection model corresponds to a classification model and is as a neural network.

15. A computer-implemented method for training a data-based fuzzing selection model, comprising the following steps:
providing program codes from a predefined program code collection;
carrying out fuzzing test methods of the program codes corresponding to the predefined code collection;
ascertaining a performance metric for each fuzzing test method of the fuzzing test methods carried out for each program code of the program codes;
ascertaining a set of one or multiple program code metrics for each of the program codes, so that training data sets are formed, which, for each fuzzing test method and each program code tested with the fuzzing test method, associate a set of the one or multiple program code metrics with the corresponding performance metric;
creating the data-based fuzzing selection model based on the training data sets, so that a performance metric is associated with each set of one or multiple program code metrics.

16. The method as recited in claim 15, wherein each of the fuzzing test methods is characterized by a fuzzing software tool used, and by: (i) seed data used and/or (ii) a dictionary used, and/or (iii) one or multiple of the following fuzzing test parameters or fuzzing tool configurations: a limitation of an available memory, a setting of a time-out for each test case, a mode or a selection of heuristics of the fuzzing software tool, a use of a grammar, a testing period of a fuzzing test, at least one property of a data processing platform on which the fuzzing software tool is operated, an a configuration of the fuzzing software tool.

17. The method as recited in claim 15, wherein the associated performance metric characterizes the fuzzing method based on statistical features, and includes or is a function of one or multiple of the following variables: coverage of program sequence paths, a functional coverage, program line coverage, or path coverage, a number of executed program sequence paths, a number of different errors that are found, average fuzzing execution time.

18. The method as recited in claim 15, wherein the program code metrics include one or multiple of the following metrics: number of code lines, cyclomatic complexity, average quantity of program sequence paths, simple execution time, load time, number of function calls, number of memory accesses, program code size.

19. The method as recited in claim 15, wherein the data-based fuzzing selection model corresponds to a classification model and is a neural network.

20. A device configured to select a fuzzing method for carrying out fuzzing testing of a predefined program code, the device configured to:
provide program code metrics that characterize the program code to be tested;
apply the program code metrics to a data-based fuzzing selection model for ascertaining performance metrics, associated with each fuzzing method of a number of fuzzing methods, the data-based fuzzing selection model being trained to output an associated performance metric for each of the fuzzing methods;
select one or multiple of the fuzzing methods corresponding to the associated performance metrics; and
carry out fuzzing testing corresponding to the selected one or multiple fuzzing methods.

21. A non-transitory machine-readable memory medium on which is stored a computer program for selecting a fuzzing method for carrying out fuzzing testing of a predefined program code, the computer program, when executed on a data processing device, causing the data processing device to perform the following steps:
providing program code metrics that characterize the program code to be tested;
applying the program code metrics to a data-based fuzzing selection model for ascertaining performance metrics, associated with each fuzzing method of a number of fuzzing methods, the data-based fuzzing selection model being trained to output an associated performance metric for each of the fuzzing methods;
selecting one or multiple of the fuzzing methods corresponding to the associated performance metrics; and
carrying out fuzzing testing corresponding to the selected one or multiple fuzzing methods.
